(19) United States
(12) Patent Application Publication
(10) Pub. No.: US 2007/0219312 A1
(43) Pub. Date: Sep. 20, 2007

(54) SILICONE ADHESIVE COMPOSITION AND METHOD FOR PREPARING THE SAME

(76) Inventor: Jennifer Lynn David, Ballston Spa, NY (US)

Correspondence Address: GENERAL ELECTRIC CO.;GLOBAL PATENT OPERATION, 187 Danbury Road, Suite 204, Wilton, CT, 06897-4122, US

(21) Appl. No.: 11/566,102

(22) Filed: Dec. 1, 2006

Related U.S. Application Data
(60) Provisional application No. 60/783,738, filed on Mar. 17, 2006.

(51) Int. Cl. C08L 83/04

(52) U.S. Cl. 524/588; 528/15; 528/31; 528/32; 524/404; 524/424; 524/428; 524/430; 524/431; 524/432

(57) ABSTRACT

A thermal interface material composition including a blend of a polymer matrix and a thermally conductive filler having particles having a maximum particle diameter no greater than about 25 microns, wherein the polymer matrix includes an organopolysiloxane having at least two silicon-bonded alkenyl groups per molecule, an organohydrogenpolysiloxane having at least two silicon-bonded hydrogen atoms per molecule and a hydrosilyation catalyst comprising a transition metal, wherein the transition metal is present in an amount of from about 10 to about 20 ppm by weight based on the weight of the non-filler components and the molar ratio of the silicon-bonded hydrogen atoms to the silicon-bonded alkenyl groups ranges from about 1 to about 2. A method is also provided.

### CROSS-REFERENCE TO RELATED APPLICATIONS

This application claims priority from, and incorporates by reference the entirety of, U.S. Provisional Patent Application Ser. No. 60/783,738 filed on Mar. 30, 2006.

### FIELD OF THE INVENTION

The invention relates to a silicone adhesive composition and more particularly, to a silicone thermal interface material.

### BACKGROUND OF THE INVENTION

Many electrical components generate heat during periods of operation. As electronic devices become denser and more highly integrated, the heat flux increases exponentially. The devices also need to operate at lower temperatures for performance and reliability considerations. The temperature difference between the heat generating part of the device and the ambient temperature is reduced, which decreases the thermodynamic driving force for heat removal. The increased heat flux and reduced thermodynamic driving force requires increasingly sophisticated thermal management techniques to facilitate heat removal during periods of operation.

Thermal management techniques often involve the use of some form of heat dissipating unit to conduct heat away from high temperature areas in an electrical system. A heat dissipating unit is a structure formed from a high thermal conductivity material that is mechanically coupled to a heat generating unit to aid in heat removal. Heat from the heat generating unit flows into the heat dissipating unit through the mechanical interface between the units.

In a typical electronic package, a heat dissipating unit is mechanically coupled to the heat producing component during operation by positioning a flat surface of the heat dissipating unit against a flat surface of the heat generating component and holding the heat dissipating unit in place using an adhesive or fastener. Air gaps may exist between the surface of the heat dissipating unit and the surface of the heat generating component, which reduces the ability to transfer heat through the interface between the surfaces. To address this problem, a layer of thermal interface material is placed between the heat transfer surfaces to decrease the thermal resistance between the surfaces. The thermal interface material is typically a filled polymer system, such as a one part curable silicone adhesive.

U.S. Pat. No. 5,021,494 to Toya discloses a filled thermal conductive silicone composition. The composition cures at 150° C. for one hour.

U.S. patent application Publication No. 2005/0049350 discloses a filled silicone thermal interface material composition. The composition cures at 150° C. for two hours.

A need exists for a silicone thermal interface material having shorter cure times and lower cure temperatures with high adhesion.

### SUMMARY OF THE INVENTION

In one embodiment, a thermal interface composition comprises a blend of a polymer matrix and a thermally conductive filler comprising particles having a maximum particle diameter of no greater than about 25 microns, said polymer matrix comprising an organopolysiloxane having at least two silicon-bonded alkenyl groups per molecule, an organohydrogenpolysiloxane having at least two silicon-bonded hydrogen atoms per molecule and a hydrosilylation catalyst comprising a transition metal, wherein the transition metal is present in an amount of from about 10 to about 20 ppm based on the weight of the non-filler components and the molar ratio of the silicon-bonded hydrogen atoms to the silicon-bonded alkenyl groups ranges from about 1 to about 2.

In one embodiment, a method for making a thermal interface composition comprises blending a polymer matrix and a thermally conductive filler comprising particles having a maximum particle diameter of no greater than about 25 microns, said polymer matrix comprising an organopolysiloxane having at least two silicon-bonded alkenyl groups per molecule, an organohydrogenpolysiloxane having at least two silicon-bonded hydrogen atoms per molecule and a hydrosilylation catalyst comprising a transition metal, wherein the transition metal is present in an amount of from about 10 to about 20 ppm based on the weight of the non-filler components and the molar ratio of the silicon-bonded hydrogen atoms to the silicon-bonded alkenyl groups ranges from about 1 to about 2.

In another embodiment, a one-part heat cure composition comprises a blend of a polymer matrix and a thermally conductive filler comprising particles having a maximum particle diameter of no greater than about 25 microns, said polymer matrix comprising an organopolysiloxane having at least two silicon-bonded alkenyl groups per molecule, an organohydrogenpolysiloxane having at least two silicon-bonded hydrogen atoms per molecule and a hydrosilylation catalyst comprising a transition metal, wherein the transition metal is present in an amount of from about 10 to about 20 ppm based on the weight of the non-filler components and the molar ratio of the silicon-bonded hydrogen atoms to the silicon-bonded alkenyl groups ranges from about 1 to about 2.

In another embodiment, a method for making a two-part thermal interface composition comprises mixing part A and part B in about a 1:1 ratio by weight to form the composition, wherein said composition comprises a polymer matrix and a thermally conductive filler comprising particles having a maximum particle diameter of no greater than about 25 microns, said polymer matrix comprising an organopolysiloxane having at least two silicon-bonded alkenyl groups per molecule, an organohydrogenpolysiloxane having at least two silicon-bonded hydrogen atoms per molecule and a hydrosilylation catalyst comprising a transition metal, wherein the transition metal is present in an amount of from about 10 to about 20 ppm based on the weight of the non-filler components and the molar ratio of the silicon-bonded hydrogen atoms to the silicon-bonded alkenyl groups ranges from about 1 to about 2.

The various embodiments provide a thermal interface composition having faster cure rates, lower cure temperatures and good adhesion.

### BRIEF DESCRIPTION OF THE DRAWINGS

FIG. 1 is a DMA comparison graph of G′G″ crossover temperatures for Comparative Example 2 vs. Example 1 formulations.

FIG. 2 is a graph of a DMA cure time comparison at 150° C.

FIG. 3 is a graph of a DMA cure time comparison at 80° C.

FIG. 4 is a graph showing adhesion strength as a function of cure temperature.

### DETAILED DESCRIPTION OF THE INVENTION

The singular forms “a,” “an” and “the” include plural referents unless the context clearly dictates otherwise. The endpoints of all ranges reciting the same characteristic are independently combinable and inclusive of the recited endpoint. All references are incorporated herein by reference.

The modifier “about” used in connection with a quantity is inclusive of the stated value and has the meaning dictated by the context (e.g., includes the tolerance ranges associated with measurement of the particular quantity).

“Optional” or “optionally” means that the subsequently described event or circumstance may or may not occur, or that the subsequently identified material may or may not be present, and that the description includes instances where the event or circumstance occurs or where the material is present, and instances where the event or circumstance does not occur or the material is not present.

In one embodiment, a thermal interface composition comprises a blend of a polymer matrix and a thermally conductive filler comprising particles having a maximum particle diameter of no greater than about 25 microns, said polymer matrix comprising an organopolysiloxane having at least two silicon-bonded alkenyl groups per molecule, an organohydrogenpolysiloxane having at least two silicon-bonded hydrogen atoms per molecule and a hydrosilylation catalyst comprising a transition metal, wherein the transition metal is present in an amount of from about 10 to about 20 ppm based on the weight of the non-filler components and the molar ratio of the silicon-bonded hydrogen atoms to the silicon-bonded alkenyl groups ranges from about 1 to about 2.

The polymer matrix comprises an organopolysiloxane having at least two silicon-bonded alkenyl groups per molecule, an organohydrogenpolysiloxane having at least two silicon-bonded hydrogen atoms per molecule and a hydrosilylation catalyst. The organopolysiloxane may be linear, branched, hyper-branched, dendritic or cyclic. In one embodiment, the organopolysiloxane is linear.

The organopolysiloxane has at least two alkenyl groups bonded with silicon atoms per molecule. The alkenyl groups that are bonded with silicon atoms include but are not limited to: vinyl groups, allyl groups, butenyl groups, pentenyl groups, hexenyl groups and heptenyl groups. In one embodiment, the alkenyl groups are vinyl groups.

The organopolysiloxane may have other organic groups that are bonded with the silicon atoms in addition to the alkenyl groups. The other organic groups include but are not limited to: alkyl groups, such as methyl groups, ethyl groups, propyl groups, butyl groups, pentyl groups, hexyl groups and heptyl groups, aryl groups, such as phenyl groups, tolyl groups, xylyl groups and naphthyl groups, aralkyl groups, such as benzyl groups and phenethyl groups and halogenated alkyl groups, such as chloromethyl groups, 3-chloropropyl groups and 3,3,3-trifluoropropyl groups. In one embodiment, the organopolysiloxane comprises methyl groups.

The silicon-bonded alkenyl groups in the polyorganosiloxane may be positioned at the ends and other positions of the molecular chain, such as the side chains of the molecular chains or along the backbone of the molecular chain. In one embodiment, at least one end of each molecule comprises an alkenyl group.

In one embodiment, the organopolysiloxane is a methyl vinyl polysiloxane blocked with trimethylsiloxy groups or dimethyl vinyl siloxane groups at both ends of the molecular chain or a dimethyl polysiloxane blocked with dimethylvinyl siloxane groups at both ends of the molecular chain.

The organopolysiloxane may comprise copolymers comprising siloxane units having the formula R¹₃SiO_{1/2}, siloxane units having the formula R¹₂R²SiO_{1/2}, siloxane units having the formula R¹₂SiO_{2/2} and siloxane units having the formula SiO_{4/2}; copolymers comprising siloxane units having the formula R¹₂R²SiO_{1/2}, siloxane units having the formula R¹₂SiO_{2/2} and siloxane units having the formula SiO_{4/2}; copolymers comprising siloxane units having the formula R¹R²SiO_{2/2}, siloxane units having the formula R¹SiO_{3/2} and siloxane units having the formula R²SiO_{3/2}; or mixtures of two or more of these organopolysiloxanes. In the foregoing formulas, R¹ is a monovalent hydrocarbon group other than an alkenyl group and may be an alkyl group such as a methyl group, an ethyl group, a propyl group, a butyl group, a pentyl group, a hexyl group or a heptyl group, an aryl group such as a phenyl group, a tolyl group, a xylyl group or a naphthyl group, an aralkyl group such as a phenethyl group or a halogenated alkyl group such as a chloromethyl group, a 3-chloropropyl group or a 3,3,3-trifluoropropyl group. In the foregoing formulas, R² is an alkenyl group, such as a vinyl group, an allyl group, a butenyl group, a pentenyl group, a hexenyl group or a heptenyl group.

In one embodiment, the organopolysiloxane may include copolymers of methyl vinyl siloxane and dimethyl siloxane blocked with trimethylsiloxy groups at both terminals of the molecular chain; copolymers of methyl vinyl siloxane, methyl phenyl siloxane and dimethyl siloxane blocked with trimethylsiloxy groups at both terminals of the molecular chain; copolymers of methyl vinyl siloxane and dimethyl siloxane blocked with dimethyl vinyl siloxane groups at both terminals of the molecular chain; copolymers of methyl vinyl siloxane, methyl phenyl siloxane and dimethyl siloxane blocked with dimethyl vinyl siloxane groups at both ends of the molecular chain.

There is no limitation on the viscosity of the organopolysiloxane. In one embodiment, the organopolysiloxane has a viscosity in the range of about 10 to about 500,000 centipoise as measured neat at 25° C., using a Brookfield type viscometer. In another embodiment, the organopolysiloxane has a viscosity in a range of about 50 to about 5,000 centipoise as measured neat at 25° C., using a Brookfield type viscometer.

The organohydrogenpolysiloxane acts as a crosslinking agent and has an average of at least two hydrogen atoms that are bonded to silicon atoms per molecule. The organohydrogenpolysiloxane may be linear, branched, hyper-branched, dendritic or cyclic. In one embodiment, the organohydrogenpolysiloxane is linear.

The organohydrogenpolysiloxane may have other organic groups that are bonded with the silicon atoms in addition to the hydrogen atoms. The other organic groups include but are not limited to: alkyl groups, such as methyl groups, ethyl groups, propyl groups, butyl groups, pentyl groups, hexyl groups and heptyl groups, aryl groups, such as phenyl groups, tolyl groups, xylyl groups and naphthyl groups, aralkyl groups, such as phenethyl groups or halogenated alkyl groups, such as chloromethyl groups, 3-chloropropyl groups or 3,3,3-trifluoropropyl groups. In one embodiment, the organohydrogenpolysiloxane comprises methyl groups.

The hydrogen atoms in the organohydrogenpolysiloxane may be positioned at the ends and other positions of the molecular chains, such as the side chains of the molecular chains or along the backbone of the polymer chain. In one embodiment, the hydrogen atoms are positioned along the backbone of the polymer chain. In another embodiment, the hydrogen atoms are at the ends of the molecular chain. In another embodiment, the hydrogen atoms are at the ends of the polymer chains as well as being positioned along the backbone of the polymer chains.

In one embodiment, the organohydrogenpolysiloxane is a methylhydrogen polysiloxane blocked with trimethylsiloxy groups at both terminals of the molecular chain, dimethyl polysiloxane blocked with dimethylhydrogen siloxane groups at both terminals of the molecular chain, dimethyl polysiloxane blocked with methylhydrogen siloxane groups at both terminals of the molecular chain and methylphenyl polysiloxane blocked with dimethylhydrogen siloxane groups at both terminals of the molecular chain.

The organohydrogenpolysiloxane may comprise copolymers comprising siloxane units having the formula R¹₃SiO_{1/2}, siloxane units having the formula R¹₂HSiO_{1/2} and siloxane units having the formula SiO_{4/2}, copolymers comprising siloxane units having the formula R¹₂HSiO_{1/2} and siloxane units having the formula SiO_{4/2}, copolymers comprising siloxane units having the formula R¹HSiO_{2/2}, siloxane units having the formula R¹SiO_{3/2} and siloxane units having the formula HSiO_{3/2}, copolymers comprising siloxane units having the formula R¹HSiO_{2/2}, siloxane units having the formula R¹₂SiO_{2/2} and siloxane units having the formula R¹₂HSiO₁₀₂ or mixtures of two or more of these copolymers. In the foregoing formulas, R¹ is a monovalent hydrocarbon group other than an alkenyl group and is an alkyl group, such as a methyl group, an ethyl group, a propyl group, a butyl group, a pentyl group, a hexyl group or a heptyl group, an aryl group, such as a phenyl group, a tolyl group, a xylyl group or a naphthyl group, an aralkyl group, such as a benzyl group or a phenethyl group or a halogenated alkyl group, such as a chloromethyl group, a 3-chloropropyl group or a 3,3,3-trifluoropropyl group.

In one embodiment, the organohydrogenpolysiloxane may include copolymers of methylhydrogen siloxane and dimethyl siloxane blocked with trimethylsiloxy groups at both terminals of the molecular chain, copolymers of methylhydrogen siloxane, methylphenyl siloxane and dimethyl siloxane blocked with trimethylsiloxy groups at both terminals of the molecular chain, copolymers of methylhydrogen siloxane and dimethyl siloxane blocked with dimethylhydrogen siloxane groups at both ends of the molecular chain and copolymers of methylphenyl siloxane and dimethyl blocked with dimethylhydrogen siloxane groups at both terminals of the molecular chain.

There is no limitation on the viscosity of the organohydrogenpolysiloxane. In one embodiment, the organohydrogenpolysiloxane has a viscosity in the range of about 1 to about 500,000 centipoise as measured neat at 25° C., using a Brookfield viscometer. In another embodiment, the organohydrogenpolysiloxane has a viscosity in a range of about 5 to about 5,000 centipoise as measured neat at 25° C., using a Brookfield viscometer.

The molar ratio of hydrogen atoms bonded to silicon atoms in the organohydrogenpolysiloxane per alkenyl group in the organopolysiloxane is from about 1 to about 2. In another embodiment, the molar ratio is from about 1.3 to about 1.6. In another embodiment, the molar ratio is from about 1.4 to about 1.5.

The organohydrogenpolysiloxane may be in an amount of from about 0.1 to about 50 parts by weight per 100 parts by weight of the organopolysiloxane. In another embodiment, the amount is in a range of from about 0.1 to about 10 parts by weight per 100 parts by weight of the organopolysiloxane.

The hydrosilylation catalyst comprises a transition metal. In one embodiment, the transition metal is any compound comprising Group 8-10 transition metals, such as ruthenium, rhodium, platinum and palladium. In one embodiment, the transition metal is platinum. The platinum may be in the form of complexes, such as fine platinum powder, platinum black, platinum adsorbed on solid supports such as alumina, silica or activated carbon, choroplatinic acid, platinum tetrachloride, platinum compounds complexed with olefins or alkenyl siloxanes, such as divinyltetramethyldisiloxane or tetramethyltetravinylcyclotetrasiloxane.

The transition metal is present in an amount of from about 10 to about 20 ppm by weight based on the total weight of the non-filler components. In another embodiment, the transition metal is present in an amount of from about 12 to about 19 ppm based on the total weight of the non-filler components. In another embodiment, the transition metal is present in an amount of from about 14 to about 17 ppm based on the total weight of the non-filler components.

In one embodiment, the polymer matrix may comprise an adhesion promoter. Adhesion promoters include alkoxy- or aryloxysilanes, such as γ-aminopropyltrimethoxysilane, 3-glycidoxypropyltrimethoxysilane, bis(trimethoxysilylpropyl)fumarate, or tetracyclosiloxanes modified with acryloxytrimethoxysilyl or methacryloxypropyltrimethoxysilyl functional groups, oligosiloxanes containing an alkoxy silyl functional group, oligosiloxanes containing an aryloxysilyl functional group, polysiloxanes containing an alkoxysilyl functional group, polysiloxanes containing an aryloxysilyl functional group, cyclosiloxanes containing an alkoxysilyl functional group, cyclosiloxanes containing alkoxysilyl and Si—H functional groups, cyclosiloxanes containing an aryloxysilyl functional group, titanates, trialkoxy aluminum, tetraalkoxysilanes, and mixtures thereof.

Adhesion promoters may be added in an amount from 0 to about 30 parts by weight per 100 parts by weight of the organopolysiloxane. In one embodiment, the amount of the adhesion promoters is from about 0.001 to about 15 parts by weight per 100 parts by weight of the organopolysiloxane. In another embodiment, the amount of the adhesion promoter is from about 0.1 to about 10 parts by weight per 100 parts by weight of the organopolysiloxane.

In one embodiment, the polymer matrix may comprise a catalyst inhibitor to modify the curing profile and improve the shelf life. Catalyst inhibitors include phosphine or phosphite compounds, amine compounds, isocyanurates, alkynyl alcohol, maleic esters, mixtures thereof and any other compounds known to those skilled in the art. In one embodiment, the inhibitor may be a triallylisocyanurate, 2-methyl-3-butyn-2-ol, dimethyl-1-hexyn-3-ol or mixtures thereof.

Inhibitors may be added in an amount from 0 to about 10 parts by weight per 100 parts by weight of the organopolysiloxane. In one embodiment, the amount of inhibitors is from about 0.001 to about 10 parts by weight per 100 parts by weight of the organopolysiloxane. In another embodiment, the amount of inhibitor is from about 0.01 to about 5 parts by weight per 100 parts by weight of the organopolysiloxane.

Other additives may be added to the polymer matrix, such as reactive organic diluents, unreactive diluents, flame retardants, pigments, flow control agents, thixotropic agents for viscosity control and filler treatment agents.

Reactive organic diluents may be added to decrease the viscosity of the composition. Examples of reactive diluents include dienes, such as 1,5-hexadiene, alkenes, such as n-octene, styrenic compounds, acrylate or methacrylate compounds, vinyl or alkyl-containing compounds and combinations thereof.

Unreactive diluents may be added to decrease the viscosity of the formulation. Examples of unreactive diluents include aliphatic hydrocarbons, such as octane, toluene, ethylacetate, butyl acetate, 1-methoxy propyl acetate, ethylene glycol, dimethyl ether, polydimethyl siloxanes and combinations thereof.

Examples of flame retardants include phosphoramides, triphenyl phosphate (TPP), resorcinol diphosphate (RDP), bisphenol-a-diphosphate (BPA-DP), organic phosphine oxides, halogenated epoxy resin (tetrabromobisphenol A), metal oxides, metal hydroxides and combinations thereof.

Additives may be added to the polymer matrix in an amount of from 0 to about 20 parts by weight per 100 parts by weight of the organopolysiloxane. In another embodiment, additives may be added in an amount of from about 0.5 to about 10 parts by weight per 100 parts by weight of the organopolysiloxane.

The thermally conductive fillers may be reinforcing or non-reinforcing. Fillers may include particles of fumed silica, fused silica, finely divided quartz powder, amorphous silica, carbon black, carbon nanotubes, graphite, diamond, metals, such as silver, gold, aluminum or copper, silicon carbide, aluminum hydrate, metals alloys containing the elements gallium, indium, tin, zinc or any combination thereof, ceramics, such as boron nitride, boron carbide, titanium carbide, silicon carbide or aluminum nitride, metal oxides, such as aluminum oxide, magnesium oxide, beryllium oxide, chromium oxide, zinc oxide, titanium dioxide or iron oxide, thermoplastics or thermosets comprising thermally conductive fillers and processed into the from of fibers or powders and combinations thereof. In one embodiment, the thermally conductive filler is aluminum oxide, boron nitride or a combination of these two fillers.

The thermally conductive filler may be micron-sized, sub-micron-sized, nano-sized or a combination thereof. In one embodiment, the thermally conductive filler is spherical having an aspect ratio of about 1 or approximately spherical and having an aspect ratio of approximately 1. The maximum particle diameter of the thermally conductive filler particles should not exceed 25 microns. For thermally conductive fillers having platelet or fiber shapes, the maximum particle diameter is measured at the smallest dimension of the filler. For example, for a platelet shaped filler particle, the maximum particle diameter is the maximum thickness. In one embodiment, the maximum particle diameter is less than about 25 microns. In another embodiment, the maximum particle diameter is from about 0.01 to about 24 microns.

In one embodiment, the average particle diameter ranges from about 0.01 microns to about 15 microns. In another embodiment, the average particle diameter ranges from about 1 micron to about 10 microns.

In one embodiment, the thermally conductive filler is present in a range from about 100 to 800 parts by weight per 100 parts by weight of the organopolysiloxane. In another embodiment, the thermally conductive filler is present in a range from about 300 to about 750 parts by weight per 100 parts by weight of the organopolysiloxane.

In one embodiment, the thermally conductive filler is present in a range from about 10 percent by weight to about 95 percent by weight based on the weight of the total composition. In another embodiment, the thermally conductive filler is present from about 20 percent by weight to about 92 percent by weight based on the weight of the total composition.

The thermally conductive fillers may be treated prior to, during mixing or after mixing. Filler treatment is not limited to a single step of the process, but may comprise several different stages throughout the manufacturing process. Filler treatments include, but are not limited to, ball-milling, jet-milling, roll-milling (using either a 2-roll ro 3-roll mill), chemical or physical coating or capping via procedures such as treating fillers with chemicals such as silazanes, silanols, silane or siloxane compounds or polymers containing alkoxy, hydroxy or Si—H groups and any other commonly used filler-treatment reagents, and any other procedures commonly adopted by those skilled in the art.

Other reinforcing fillers may be added to the composition. Examples of suitable reinforcing fillers include fumed silica, hydrophobic precipitated silica, finely crushed quartz, diatomaceous earth, molten talc, talc, glass fibers, graphite, carbon and pigments. The additional filler may be added in an amount of from 0 to about 30 parts by weight per 100 parts of the polyorganosiloxane.

In one embodiment, a method for making a thermal interface composition comprises blending a polymer matrix and a thermally conductive filler comprising particles having a maximum particle diameter of no greater than about 25 microns, said polymer matrix comprising an organopolysiloxane having at least two silicon-bonded alkenyl groups per molecule, an organohydrogenpolysiloxane having at least two silicon-bonded hydrogen atoms per molecule and a hydrosilylation catalyst comprising a transition metal, wherein the transition metal is present in an amount of from about 10 to about 20 ppm based on the weight of the non-filler components and the molar ratio of the silicon-bonded hydrogen atoms to the silicon-bonded alkenyl groups ranges from about 1 to about 2.

The final composition can be hand-mixed or mixed by standard mixing equipment, such as dough mixers, planetary mixers, twin screw extruders, two or three roll mills and the like. The blending of the composition can be performed in batch, continuous, or semi-continuous mode by any means used by those skilled in the art.

The composition can be cured at a temperature below about 150° C. In one embodiment, the composition is cured between about 20° C. and about 100° C. In another embodiment, the composition is cured between about 50° C. and 80° C. In another embodiment, the composition is cured at 80° C. At 80° C., the cure time is less than 1 hour.

Curing typically occurs at a pressure in a range between about 1 atmosphere and about 5 tons pressure per square inch, including a range between about 1 atmosphere and about 100 pounds per square inch.

The composition has good adhesion to silicon as well as to metal substrates frequently used as heat sinks in electronic devices. The composition also has good adhesion to metal substrates treated with coatings typically used in the manufacture of heat sinks in the electronics industry. These heat sinks include but are not limited to aluminum and copper. The heat sink coatings include but are not limited to gold, chromate and nickel. The thermal interface composition can be used in devices in electronics such as computers, semiconductors, or any device where heat transfer between components is needed. Frequently, these components are made of metal, such as aluminum, copper, silicon, etc. The compositions may be applied in any situation where heat is generated and needs to be removed. For example, the composition may be utilized to remove heat from a motor or engine, to act as underfill material in a flip-chip design, to facilitate the transport of heat from the surface of a silicon chip to a heat sink, as die attach in an electronic device, and in any other applications where efficient heat-removal is desired.

In one embodiment, the compositions can be pre-formed into sheets or films and cut into any desired shape. The composition can advantageously be used to form thermal interface pads or films that are positioned between electronic components. Alternatively, the composition can be pre-applied to either the heat generating or heat dissipating unit of a device. The composition may also be applied as grease, gel and phase change material formulations.

The thermal interface material may be in the form of a one-part heat cure composition, a two-part heat cure composition or a two-part room temperature cure composition.

In another embodiment, a one-part heat cure composition comprises a blend of a polymer matrix and a thermally conductive filler comprising particles having a maximum particle diameter of no greater than about 25 microns, said polymer matrix comprising an organopolysiloxane having at least two silicon-bonded alkenyl groups per molecule, an organohydrogenpolysiloxane having at least two silicon-bonded hydrogen atoms per molecule and a hydrosilylation catalyst comprising a transition metal, wherein the transition metal is present in an amount of from about 10 to about 20 ppm based on the weight of the non-filler components and the molar ratio of the silicon-bonded hydrogen atoms to the silicon-bonded alkenyl groups ranges from about 1 to about 2.

In another embodiment, the one-part heat cure composition may be formulated as a two-part system. In one embodiment, a method for making a two-part thermal interface composition comprises mixing part A and part B in about a 1:1 ratio by weight to form the composition, wherein said composition comprises a polymer matrix and a thermally conductive filler comprising particles having a maximum particle diameter of no greater than about 25 microns, said polymer matrix comprising an organopolysiloxane having at least two silicon-bonded alkenyl groups per molecule, an organohydrogenpolysiloxane having at least two silicon-bonded hydrogen atoms per molecule and a hydrosilylation catalyst comprising a transition metal, wherein the transition metal is present in an amount of from about 10 to about 20 ppm based on the weight of the non-filler components and the molar ratio of the silicon-bonded hydrogen atoms to the silicon-bonded alkenyl groups ranges from about 1 to about 2.

In a two-part composition, the formulation is prepared in two parts, part A and part B, and stored until it is desired to combine the two parts and make the thermal interface material. The parts may be stored at room temperature, but must be kept separate from one another. Parts A and B may contain any of the components of the thermal interface material in any amount except that the organohydrogenpolysiloxane must be wholly contained in one part and the hydrosilylation catalyst must be wholly contained in the other part. In one embodiment, both part A and part B comprise filler and organopolysiloxane. In another embodiment, both part A and part B comprise equal amounts of filler and organopolysiloxane.

In one embodiment, a two-part composition may be prepared that will cure at room temperature when part A and part B are combined. In another embodiment, a two-part composition may be prepared that requires the application of heat to cure when part A and part B are combined.

Parts A and B may be blended by hand-mixing or mixing by standard mixing equipment, such as dough mixers, planetary mixers, twin screw extruders, static mixers, two or three roll mills and the like. The blending of components A and B can be performed in batch, continuous, or semi-continuous mode by any means used by those skilled in the art. In one embodiment, components A and B are mixed together in about a 1:1 weight ratio.

In order that those skilled in the art will be better able to practice the present disclosure, the following examples are given by way of illustration and not by way of limitation.

### EXAMPLES

### Example 1

Two separate thermally conductive fillers were used in this formulation. The first filler was Denka DAW-05 alumina filler having an average particle size of 5 μm and a maximum particle size of 24 μm and the second filler was Sumitomo's AA-04 alumina filler having an average particle size of 0.4-0.6 μm and a maximum of about 1 μm. The thermally conductive fillers (604.30 parts total (483.58 parts of the first filler and 120.72 parts of the second filler)) were mixed in a lab scale Ross mixer (1 quart capacity) at approximately 18 rpm for 2.5 hours at 140-160° C. The fillers were then cooled to 35-45° C., brought to atmospheric pressure and 100 parts of vinyl-stopped polydimethylsiloxane fluid (350-450 cSt, approximately 0.48 weight percent vinyl; SL6000-D1 from GE Silicones) along with 0.71 parts of a pigment masterbatch (50 weight percent carbon black and 50 weight percent of a 10,000 cSt vinyl-stopped polydimethylsiloxane fluid; M-8016 from GE Toshiba) and a portion of the hydride fluid was added, 1.04 parts of hydride functionalized polyorganosiloxane fluid (approximately 0.82 weight percent hydride; 88466 from GE Silicones) The formulation was mixed at approximately 18 rpm for 6 minutes to incorporate the fluids and pigment. The temperature was then raised to 140-160° C. and the mixture was stirred at approximately 18 rpm for an additional 1.5 hours at a vacuum pressure of 25-30 inches Hg. The formulation was cooled to approximately 30° C. and the following components were added: 0.413 parts triallyl isocyanurate, 0.043 parts dimethyl-1-hexyn-3-ol (Surfinol® 61) and 0.094 parts of a tetramethyltetravinylcyclotetrasiloxane-complexed platinum catalyst (GE Silicones, 88346, which is a solution of about 1.7 wt. % platinum in vinyl-D4 (This catalyst loading results in a platinum content of 14.65 ppm based on the non-filler components of the final formulation)). The components were incorporated by stirring for 8 minutes at approximately 18 rpm. Final components were then added to the mixer: 3.14 parts of a first adhesion promoter (a cyclosiloxane containing alkoxysilyl and Si—H functional groups, GE Toshiba, A501S), 2.08 parts of a second adhesion promoter (glycidoxypropyltrimethoxysilane) and the remaining amount of the hydride fluid, 2.10 parts of hydride functionalized polyorganosiloxane fluid (approximately 0.82 weight percent hydride). H:Vi molar ratio for the formulation is 1.399. The components were incorporated by stirring for 5 minutes at approximately 18 rpm. The final formulation was mixed for an additional 3 minutes at approximately 18 rpm and at a vacuum pressure of 25-30 inches Hg. The formulation was removed from the mixer and immediately filtered through a 100 mesh filter screen. Prior to testing, the material was then placed under vacuum for 3-8 minutes at 25-30 inches Hg to remove any residual entrapped air.

### Comparative Example 2

Two separate thermally conductive fillers were used in this formulation. The first filler was Denka DAW-05 alumina filler having an average particle size of 5 μm and a maximum particle size of 24 μm and the second filler was Sumitomo's AA-04 alumina filler having an average particle size of 0.4-0.6 μm and a maximum particle size of about 1 μm. The thermally conductive fillers (604.30 parts total (483.58 parts of the first filler and 120.72 parts of the second filler)) were mixed in a lab scale Ross mixer (1 quart capacity) at approximately 18 rpm for 2.5 hours at 140-160° C. The fillers were then cooled to 35-45° C., brought to atmospheric pressure, and 100 parts of vinyl-stopped polydimethylsiloxane fluid (350-450 cSt, approximately 0.48 weight percent vinyl; S16000-D1 from GE Silicones) along with 0.71 parts of a pigment masterbatch (50 weight percent carbon black and 50 weight percent of a 10,000 cSt vinyl-stopped polydimethylsiloxane fluid; M-8016 from GE Toshiba) and a portion of the hydride fluid was added, 0.70 parts of hydride functionalized polyorganosiloxane fluid (approximately 0.82 weight percent hydride; 88466 from GE Silicones) The formulation was mixed at approximately 18 rpm for 6 minutes to incorporate the fluids and pigment. The temperature was then raised to 140-160° C. and the mixture was stirred at approximately 18 rpm for an additional 1.5 hours at a vacuum pressure of 25-30 inches Hg. The formulation was cooled to approximately 30° C. and the following components were added: 0.54 parts triallyl isocyanurate, 0.06 parts dimethyl-1-hexyn-3-ol (Surfinol® 61) and 0.04 parts of a tetramethyltetravinylcyclotetrasiloxane-complexed platinum catalyst (GE Silicones, 88346, which is a solution of about 1.7 wt. % platinum in vinyl-D4 (This catalyst loading results in a platinum content of 5.85 ppm by weight based on the non-filler components of the final formulation.)). The components were incorporated by stirring for 8 minutes at approximately 18 rpm. Final components were then added to the mixer: 3.14 parts of a first adhesion promoter (a cyclosiloxane containing alkoxysilyl and Si—H functional groups, GE Toshiba, A501S), 2.08 parts of a second adhesion promoter (glycidoxypropyltrimethoxysilane) and the remaining amount of the hydride fluid, 1.42 parts of hydride functionalized polyorganosiloxane fluid (approximately 0.82 weight percent hydride). H:Vi molar ratio for the formulation is 0.947. The components were incorporated by stirring for 5 minutes at approximately 18 rpm. The final formulation was mixed for an additional 3 minutes at approximately 18 rpm and at a vacuum pressure of 25-30 inches Hg. The formulation was removed from the mixer and immediately filtered through a 100 mesh filter screen. Prior to testing, the material was then placed under vacuum for 3 minutes at 25-30 inches Hg to remove any residual entrapped air.

### Example 3

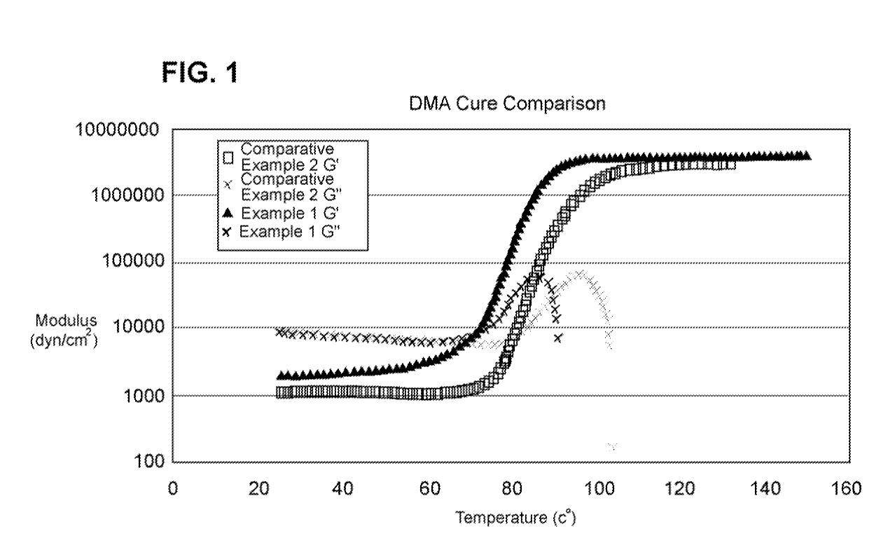

Dynamic mechanical analysis (DMA) was completed using a TA Instruments Ares-LS2 to compare gelation points for the two samples (Example 1 vs. Comparative Example 2) as temperature ramped from 25° C. to 150° C. at a rate of 2 degrees C. per minute with a parallel plate geometry. See Table 1 and FIG. 1.

The storage (elastic) modulus, G′, scales directly with molecular weight in polymeric systems. As cure begins, the molecular weight increases, and the G′ value increases. When G′ curves are compared for Example 1 and Comparative Example 2, the increase in G′ for the Example 1 sample is shown to occur at a much lower temperature than the Comparative Example 2 sample. The slope of the G′ line is positive for the Example 1 sample, starting at about 30° C. In contrast, the slope of the G′ curve for the Comparative Example 2 sample remains at zero until approximately 65° C. This difference highlights the fact that the Example 1 sample begins its curing reaction at a much lower temperature than the Comparative Example 2 sample.

The crossover point between the storage and loss moduli for a material is a property known as the “gelation point”. At this point, the material has achieved a sufficient degree of crosslinking that it is said to be an infinite network. The crossover point is recognized as the first point of cure, although full cure requires continued application of heat to reach a plateau value for the storage modulus. This experiment shows that the Example 1 sample has a lower gelation temperature than does the Comparative Example 2 sample. The gelation temperature is lower by 10° C. in the case of the Example 1 sample.

The plateau temperature is the point at which cure is said to be complete and the G′ slope returns to zero. The data collected in this experiment shows that the Example 1 material achieves a plateau (complete cure) about 35° C. lower than the Comparative Example 2 sample.

TABLE 1
Comparative Transition Temperatures for Example 1 vs. Comparative
Example 2

| | Positive G′ Slope | G′G″ Crossover | Plateau |
|---|---|---|---|
| | Temperature (C.) | Temperature (C.) | Temperature (C.) |
| Ex. 1 | 30 | 72 | 95 |
| Comparative | 65 | 82 | 130 |
| Ex. 2 | | | |

### Example 4

This example tested the time required to achieve full cure as a function of different cure temperatures. The G′G″ crossover point indicates onset of cure and full cure is indicated by a plateau in the storage modulus (G′) in a DMA experiment. Table 2, below, shows that the final G′ value at the end of the isothermal hold (final G′) is essentially the same as the maximum G′ value (maximum G′) attained throughout each of the runs. The maximum G′ value was used for the calculations to determine the extent of cure.

Table 2 shows that the maximum G′ value for the Example 1 sample is reduced by only 8% when the cure temperature is reduced from 150° C. to 80° C. This same reduction in cure temperature for the Comparative Example 2 sample results in a reduction of 26% in the maximum G′ value. A lower plateau value for G′ indicates a reduction in crosslink density. The larger the reduction in G′, the larger the reduction in crosslink density and the less cured the material is. The fact that the Comparative Example 2 sample shows a reduction over three times that of the Example 1 sample when cured at 80° C. is another indication that the Example 1 sample has a much better cure than the Comparative Example 2 sample at the low temperature of 80° C.

TABLE 2
Comparison of Maximum G′ Storage Modulus for Comparative Example 2 vs. Example 1 Samples

| | Cure | | | % Difference | % Reduction in |
|---|---|---|---|---|---|
| | Temperature | Final G′ | Maximum G′ | Maximum G′ vs. | Maximum G′ at |
| | ° C. | dyn/cm² | dyn/cm² | Final G′ | 80° C. vs. 150° C. |
| Example 1 | 150 | 3458600 | 3558300 | 3 | |
| Example 1 | 80 | 3254400 | 3285000 | 1 | 8 |
| Comparative Ex. 2 | 150 | 3861500 | 3880000 | 0 | |
| Comparative Ex. 2 | 80 | 2853100 | 2875400 | 1 | 26 |

In Table 3, the elapsed time needed (in minutes) for each sample to achieve 90%, 95% and 99% of its maximum G′ value for each temperature is recorded. The results show that the Example 1 sample achieves 99% of its maximum G′ value after about 35 minutes at 80° C. As shown in Table 2 and discussed above, the maximum G′ value achieved by the Example 1 sample tested at 80° C. is only 8% less than the maximum G′ for the Example 1 sample tested at 150° C. In contrast, the Comparative Example 2 sample requires over 4.5 hours (278 minutes) to achieve 99% of its maximum G′ value at 80° C. This translates to a reduction in cure time of about 87% for the Example 1 sample. Furthermore, as explained above, the maximum G′ value for the Comparative Example 2 sample cured at 80° C. is 26% less than its maximum G′ value when cured at 150° C. This means that even after 4.5 hours at 80° C., the Comparative Example 2 sample has achieved a much lower degree of cure than the Example 1 sample achieved in only 35 minutes at that temperature.

TABLE 3
Comparison of Time to Achieve Maximum G′ Values for Comparative
Example 2 vs. Example 1 Samples

| | | | | | % Reduction |
|---|---|---|---|---|---|
| | | | | | in Cure Time |
| | | Time (min) to | Time (min) to | Time (min) to | for Ex. 1 vs. |
| | Cure | reach 90% of | reach 95% of | reach 99% of | Comparative |
| | Temperature | Maximum G′ | Maximum G′ | Maximum G′ | Ex. 2 |
| | ° C. | Value (t − 90) | Value (t − 95) | Value (t − 99) | Formulation |
| Example 1 | 150 | 2.1 | 2.3 | 16.3 | 55 |
| Example 1 | 80 | 19.3 | 23.4 | 35.4 | 87 |
| Comparative Ex. 2 | 150 | 3.2 | 13.7 | 36.8 | |
| Comparative Ex. 2 | 80 | 128.9 | 183.5 | 278.0 | |

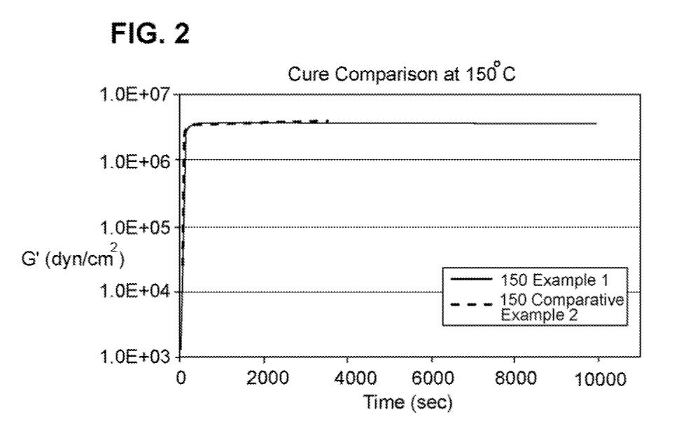

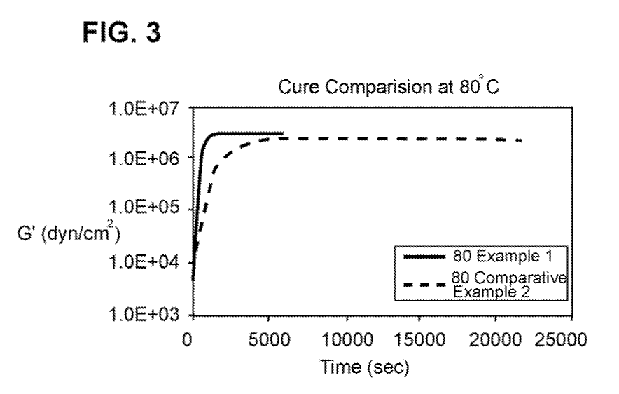

FIGS. 2 and 3 show the comparative cure profiles of Example 1 and Comparative Example 2 samples.

### Example 5

The storage modulus of a material measures when a material has achieved an optimal level of crosslink density and a second and equally important component of “useful” cure for an adhesive material is the development of sufficient adhesion strength. The mechanisms of the reactions that result in crosslinking and adhesion can be different in adhesive systems, but a sufficient degree of crosslinking and adhesion are both required if the material is to be considered “cured” to a useful degree.

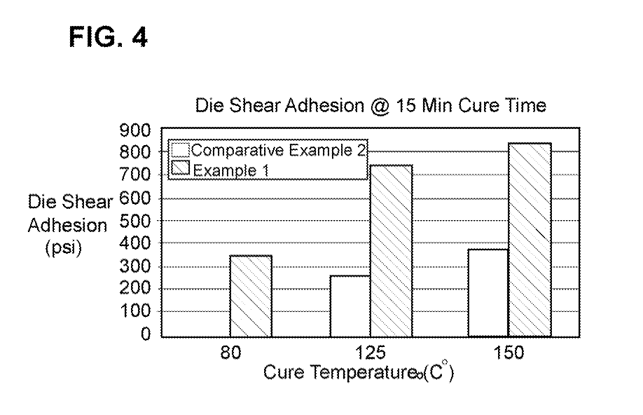

Table 4 and FIG. 4 illustrate the difference in the adhesive strength for the Example 1 and the Comparative Example 2 samples. Test samples were prepared by dispensing a small amount of material onto a nickel-coated copper substrate, placing an 8 mm×8 mm silicon coupon on top, compressing with 10 psi of force, and curing at the indicated times and temperatures. The assemblies were then tested for die shear adhesion using a Dage 4000 Die Shear tester with a 100 Kg load cell. The values reported for each sample are the average of 9 replicate measurements. Samples were conditioned for a minimum of three days at room temperature. This delay between cure date and test date was used to ensure that stable physical properties were achieved prior to test.

The results show that the Example 1 sample can achieve a cure of 344 psi after only 15 minutes cure at 80° C. As was shown in the DMA cure data, above, the material is not fully crosslinked at this point; yet the adhesion strength is already well above the minimum acceptable values for typical applications. By contrast, the Comparative Example 2 sample has not achieved sufficient adhesion or crosslinking after 15 minutes at 80° C. when tested in the same manner. The Comparative Example 2 sample has achieved a die shear adhesion value of over 700 psi after only 15 min at 125° C. The Comparative Example 2 sample does not approach such a high adhesion level, even after curing at the higher temperature of 150° C. for 15 minutes.

TABLE 4
Comparison of Die Shear Adhesion Strength for Example 1 vs.
Comparative Example 2 Samples

| | 15 min @ | 15 | |
|---|---|---|---|
| | 80° C. | min @ 125° C. | 15 min @ 150° C. |
| Example 1 (psi) | 344 (100) | 739 (97) | 841 (70) |
| Ave (stdev) | | | |
| Comparative | 0.5 (0.1) | 262 (39) | 380 (40) |
| Example 2 (psi) | UNCURED | | |
| Ave (stdev) | | | |

### Example 6

Additional formulations were prepared using the input amounts listed in Table 5. A base containing the thermally conductive fillers, the vinyl stopped polydimethylsiloxane fluid, the pigment masterbatch, and a portion of the hydride fluid (33% of the total amount needed for the formulation) was prepared following the process described in Example 1 in a Ross type planetary mixer. After the 1.5 hour heated vacuum mix step, as described in Example 1, the base material was cooled to room temperature and removed from the Ross mixer. The base was used to prepare the formulations of Example 6. These formulations were prepared by mixing the base with the remaining inputs listed in Table 5. These mixes were performed on a small scale using a high shear SpeedMixer by Hauschild.

The following general procedure describes the mixing process utilized for all of the formulations of Example 6.

A portion of the base material was added to the mix cup along with the target amounts of triallyl isocyanurate and dimethyl-1-hexyn-3-ol. The formulation was mixed at 1800 rpm for approximately 10 seconds. The target amount of tetramethyltetravinylcyclotetrasiloxane-complexed platinum catalyst was added to the mix cup and the formulation was mixed at 1800 rpm for approximately 10 seconds. The target amount of the A501S adhesion promoter and the target amount of the glycidoxypropyltrimethoxysilane adhesion promoter and the remaining amount of the hydride fluid were added to the mix cup and the formulation was mixed at 1800 rpm for approximately 10 seconds. Prior to testing, the material was then placed under vacuum for 3-8 minutes at 25-30 inches Hg to remove any residual entrapped air.

TABLE 5

| | Example 6 | | | | | | | | |
|---|---|---|---|---|---|---|---|---|---|
| Formulation (Parts) | 6-1 | 6-2 | 6-3 | 6-4 | 6-5 | 6-6 | 6-7 | 6-8 | 6-9 |
| DAW-05 | 483.6 | 483.6 | 483.6 | 483.6 | 483.6 | 483.6 | 483.6 | 483.6 | 483.6 |
| AA-04 | 120.7 | 120.7 | 120.7 | 120.7 | 120.7 | 120.7 | 120.7 | 120.7 | 120.7 |
| SL6000-D1 | 100.0 | 100.0 | 100.0 | 100.0 | 100.0 | 100.0 | 100.0 | 100.0 | 100.0 |
| M-8016 | 0.71 | 0.71 | 0.71 | 0.71 | 0.71 | 0.71 | 0.71 | 0.71 | 0.71 |
| 88346 | 0.08 | 0.11 | 0.09 | 0.11 | 0.08 | 0.08 | 0.11 | 0.11 | 0.08 |
| TAIC | 0.23 | 0.23 | 0.32 | 0.40 | 0.40 | 0.23 | 0.40 | 0.23 | 0.40 |
| Surfinol 61 | 0.02 | 0.04 | 0.03 | 0.04 | 0.02 | 0.04 | 0.02 | 0.02 | 0.04 |
| A501S | 3.80 | 3.80 | 3.14 | 3.80 | 3.80 | 2.48 | 2.48 | 2.48 | 2.48 |
| GPS-M | 1.41 | 1.41 | 2.08 | 1.41 | 1.41 | 2.74 | 2.74 | 2.74 | 2.74 |
| 88466 | 3.32 | 2.95 | 3.14 | 3.32 | 2.95 | 2.95 | 2.95 | 3.32 | 3.32 |
| H:Vi ratio | 1.5 | 1.3 | 1.4 | 1.5 | 1.3 | 1.3 | 1.3 | 1.5 | 1.5 |
| ppm Pt | 12.55 | 16.75 | 14.65 | 16.75 | 12.55 | 12.55 | 16.75 | 16.75 | 12.55 |
| T − 95 at 80 C. | 11.7 | 12.8 | 18.1 | 18.9 | 21.6 | 25.7 | 32.7 | 39.1 | 52.7 |
| (min) | | | | | | | | | |
| Ultimate Die Shear | 832 | 846 | 941 | 810 | 810 | 906 | 845 | 936 | 787 |
| Adhesion (psi) | | | | | | | | | |
| at cure conditions: | | | | | | | | | |
| 30 min/80 C. | | | | | | | | | |
| Viscosity | 25 | 0 | 5 | 0 | 8 | 13 | 126 | 60 | 2 |
| Increase (%) | | | | | | | | | |
| with 24 hr storage | | | | | | | | | |

DAW-05 is an alumina filler having an average particle size of 5 μm and a maximum particle size of 24 μm.
AA-04 is an alumina filler having an average particle size of 0.4–0.6 μm and a maximum of about 1 μm.
SL6000-D1 is a vinyl-stopped polydimethylsiloxane fluid (350–450 cSt, approximately 0.48 weight percent vinyl.
M-8016 is a pigment masterbatch (50 weight percent carbon black and 50 weight percent of a 10,000 cSt vinyl-stopped polydimethylsiloxane fluid.)
88346 is a tetramethyltetravinylcyclotetrasiloxane-complexed platinum catalyst (1.7 wt. % platinum in vinyl-D4).
TAIC is triallyl isocyanurate.
Surfinol ® 61 is dimethyl-1-hexyn-3-ol.
A501S is a cyclosiloxane containing alkoxysilyl and Si-H functional groups.
GPS-M is glycidoxypropyltrimethoxysilane.
88466 is a hydride functionalized polyorganosiloxane fluid (approximately 0.82 weight percent hydride).

The samples were cured and a die shear test was performed as described in Example 5. A cured time test was performed at an isothermal hold temperature of 80° C. using an instrument similar to the Ares-LS2 as described in Example 3. The T-95 values are the times to achieve 95% cure. Viscosity was also measured based on 24 hour storage at 25° C. The viscosity was measured neat at 25° C., using a parallel plate rheometer at a shear rate of 10/s.

While typical embodiments have been set forth for the purpose of illustration, the foregoing descriptions should not be deemed to be a limitation on the scope herein. Accordingly, various modifications, adaptations and alternatives may occur to one skilled in the art without departing from the spirit and scope herein.

1. A thermal interface composition comprises a blend of a polymer matrix and a thermally conductive filler comprising particles having a maximum particle diameter of no greater than about 25 microns, said polymer matrix comprising an organopolysiloxane having at least two silicon-bonded alkenyl groups per molecule, an organohydrogenpolysiloxane having at least two silicon-bonded hydrogen atoms per molecule and a hydrosilylation catalyst comprising a transition metal, wherein said transition metal catalyst is present in an amount of from about 10 to about 20 ppm based on the weight of the non-filler component and the molar ratio of the silicon-bonded hydrogen atoms to the silicon-bonded alkenyl groups ranges from about 1 to about 2.

2. The composition of claim 1 wherein the organopolysiloxane is linear.

3. The composition of claim 1 wherein the alkenyl groups are vinyl groups.

4. The composition of claim 3 wherein the alkenyl groups are at the ends of the molecular chain.

5. The composition of claim 1 wherein the organopolysiloxane is a dimethyl polysiloxane blocked with dimethyl vinyl siloxane groups at both ends of the molecule.

6. The composition of claim 1 wherein the organohydrogenpolysiloxane comprises methyl groups.

7. The composition of claim 1 wherein the hydrogen atoms are positioned along the backbone of the molecular chain and at the ends of the molecular chain.

8. The composition of claim 1 wherein the organohydrogenpolysiloxane is a copolymer of methylhydrogen siloxane and dimethyl siloxane blocked with dimethylhydrogen siloxane groups at both ends of the molecular chain.

9. The composition of claim 1 wherein the molar ratio of hydrogen atoms bonded to silicone atoms in the organohydrogenpolysiloxane per alkenyl group in the organopolysiloxane is from about 1.3 to about 1.6.

10. The composition of claim 9 wherein the molar ratio of hydrogen atoms bonded to silicone atoms in the organohydrogenpolysiloxane per alkenyl group in the organopolysiloxane is from about 1.4 to about 1.5.

11. The composition of claim 1 wherein the transition metal is present in an amount of from about 12 to about 19 ppm based on the total weight of the non-filler components of the composition.

12. The composition of claim 11 wherein the transition metal is present in an amount of from about 14 to about 17 ppm based on the total weight of the non-filler components of the composition.

13. The composition of claim 1 further comprising an adhesion promoter.

14. The composition of claim 1 further comprising a catalyst inhibitor.

15. The composition of claim 1 wherein the thermally conductive filler is selected from the group consisting of: boron nitride, boron carbide, titanium carbide, silicon carbide, aluminum nitride, aluminum oxide, magnesium oxide, beryllium oxide, chromium oxide, zinc oxide, titanium dioxide and iron oxide.

16. The composition of claim 1 wherein the thermally conductive filler has a maximum particle diameter of less than 25 microns.

17. The composition of claim 1 wherein the thermally conductive filler has an average particle diameter from about 0.01 microns to about 15 microns.

18. A method for making a thermal interface composition comprising blending a polymer matrix and a filler comprising particles having a maximum particle diameter of no greater than about 25 microns, said polymer matrix comprising an organopolysiloxane having at least two silicon-bonded alkenyl groups per molecule, an organohydrogenpolysiloxane having at least two silicon-bonded hydrogen atoms per molecule and a hydrosilylation catalyst comprising a transition metal, wherein said transition metal is present in an amount of from about 10 to about 20 ppm based on the weight of the non-filler components and the molar ratio of the silicon-bonded hydrogen atoms to the silicon-bonded alkenyl groups ranges from about 1 to about 2.

19. The method of claim 18 wherein the alkenyl groups are vinyl groups.

20. The method of claim 18 wherein the organopolysiloxane is a dimethyl polysiloxane blocked with dimethyl vinyl siloxane groups at both ends of the molecule.

21. The method of claim 18 wherein the organohydrogenpolysiloxane comprises methyl groups.

22. The method of claim 18 wherein the organohydrogenpolysiloxane is a copolymer of methylhydrogen siloxane and dimethyl siloxane blocked with dimethylhydrogen siloxane groups at both ends of the molecular chain.

23. The method of claim 18 wherein the molar ratio of hydrogen atoms bonded to silicone atoms in the organohydrogenpolysiloxane per alkenyl group in the organopolysiloxane is from about 1.3 to about 1.6.

24. The method of claim 23 wherein the molar ratio of hydrogen atoms bonded to silicone atoms in the organohydrogenpolysiloxane per alkenyl group in the organopolysiloxane is from about 1.4 to about 1.5.

25. The method of claim 18 wherein the transition metal is present in an amount of from about 12 to about 19 ppm based on the total weight of the non-filler components of the composition.

26. The method of claim 25 wherein the transition metal is present in an amount of from about 14 to about 17 ppm based on the total weight of the non-filler components of the composition.

27. The method of claim 18 further comprising an adhesion promoter.

28. The method of claim 18 further comprising a catalyst inhibitor.

29. The method of claim 18 wherein the thermally conductive filler is selected from the group consisting of: boron nitride, boron carbide, titanium carbide, silicon carbide, aluminum nitride, aluminum oxide, magnesium oxide, beryllium oxide, chromium oxide, zinc oxide, titanium dioxide and iron oxide.

30. A one-part heat cure composition comprising a blend of a polymer matrix and a thermally conductive filler comprising particles having a maximum particle diameter of no greater than about 25 microns, said polymer matrix comprising an organopolysiloxane having at least two silicon-bonded alkenyl groups per molecule, an organohydrogenpolysiloxane having at least two silicon-bonded hydrogen atoms per molecule and a hydrosilylation catalyst comprising a transition metal, wherein said transition metal is present in an amount of from about 10 to about 20 ppm by weight based on the weight of the non-filler components and the molar ratio of the silicon-bonded hydrogen atoms to the silicon-bonded alkenyl groups ranges from about 1 to about 2.

31. A method for making a two-part thermal interface composition comprises mixing part A and part B in a 1:1 ratio by weight to form the composition, wherein said composition comprises a polymer matrix and a thermally conductive filler comprising particles having a maximum particle diameter of no greater than about 25 microns, said polymer matrix comprising an organopolysiloxane having at least two silicon-bonded alkenyl groups per molecule, an organohydrogenpolysiloxane having at least two silicon-bonded hydrogen atoms per molecule and a hydrosilylation catalyst comprising a transition metal, wherein said transition metal is present in an amount of from about 10 to about 20 ppm based on the weight of the non-filler components and the molar ratio of the silicon-bonded hydrogen atoms to the silicon-bonded alkenyl groups ranges from about 1 to about 2.
